(19) United States
(12) Patent Application Publication
(10) Pub. No.: US 2020/0020248 A1
(43) Pub. Date: Jan. 16, 2020

(54) Process Of Using Audio Video Scenes For Student Assessments

(71) Applicant: Adriana Lavi, Ladera Ranch, CA (US)

(72) Inventor: Adriana Lavi, Ladera Ranch, CA (US)

(21) Appl. No.: 16/035,678

(22) Filed: Jul. 15, 2018

(51) Int. Cl. G09B 19/04; G09B 5/06; G09B 7/00; G10L 15/19; G10L 15/18

(52) U.S. Cl. CPC G09B 19/04; G09B 5/065; G10L 15/1822; G10L 15/19; G09B 7/00

(57) ABSTRACT

All current student communicative or cognitive assessments use either written word questions or picture with word questions or audio with picture and word questions to measure students comparatively. These assessments lack the real-life audio and video communicative expressions that can be provided to the student for evaluation. Audio Video Scenes provide more than ten-fold the information that can be assessed with a student, and also communicative and cognitive information that could otherwise never be measured or detected using current assessments. As a result of using this process of real-life audio video scenes, the assessment of the student is more precise and one can assess more information about the student's capabilities relative to other students in the same comparative groups.

### BACKGROUND OF THE INVENTION

Currently, the process of assessing a student's communicative or cognitive skills involves several process steps. Step 1 involves the student having to either read some type of words, or look at some type of still picture, or listening to some type of words. Step 2 involves presenting a question related to the items in step 1. Step 3 involves scoring the response. Step 4 involves assessing the student comparatively based on the response to each question. Currently there are no student assessments that use audio video scenes in step 1 of the process to assess students comparatively.

All current student communicative or cognitive assessments use either written word questions or picture with word questions or audio with still picture and word questions to measure students comparatively.

These assessments lack the real-life audio and video communicative expressions that can be provided to the student for evaluation, that provide more than ten-fold the information that can be assessed with a student and also communicative and cognitive information that could otherwise never be measured or detected using current assessment items in step 1 of the process.

As a result of using this process of real-life audio video scenes, the assessment of the student is more precise and one can assess more information about the student's capabilities relative to other students in the same comparative groups.

### BRIEF SUMMARY OF THE INVENTION

This invention is the process of using audio video scenes (verbal sound and voice communications from various actors and visual streaming cues from actors) that portray communicative expressions and situations in particular scenes where something goes wrong or something goes correctly. After the student reviews each of the scenes, an assessor asks standardized questions regarding each of the scenes. The student's responses to the questions are scored on a score sheet after viewing each of the many different scenes. The scores are tabulated for the individual student and ranked against comparative groups.

### DETAILED DESCRIPTION OF THE INVENTION

Current large scale student communication skill assessments (both verbal and non-verbal skill assessments) use a process which involves several process steps. Step 1 involves the student having to either a) read some type of words, or b) look at some type of still picture, or c) listening to some type of words or d) some combination of a) thru c). Step 2 involves presenting a question related to the items in step 1. Step 3 involves scoring the response. Step 4 involves assessing the student comparatively (standardized testing scores from various groups such as age) based on the response to each question. Currently there are no student assessments that use audio video scenes in step 1 of the process to assess students comparatively.

This invention uses Audio Video Scenes, ‘Videos,’ in step 1 of the assessment process.

Audio Video Scenes, ‘Videos’, can be defined as verbal streaming sound and voice communications from various actors in combination with visual streaming pictures and cues from actors. In Wikipedia, Video is defined as ‘an electronic medium for the recording, copying, playback, broadcasting, and display of moving visual media.’ Webster defines Scene as ‘a division of an act in a play during which the action takes place in a single place without a break in time: a part of a play, movie, story, etc., in which a particular action or activity occurs.’ Webster defines videos as ‘relating to the pictures that are seen in a recording or broadcast: of, relating to, or involving videos that are shown on a television or computer screen.’ In this context, Audio Video Scenes, ‘Video” can be defined as all the above references and summarized as, real life scenes with audio/voice sounds of the actors as the actions/expressions of the actors are streaming in a visual form, along with the audio/voice as on a television or computer screen.

Communication is defined as a process in which people generate meaning through the exchange of verbal and nonverbal messages in specific contexts and the production and reception of verbal or nonverbal information among human beings that involves the use of symbols known as language received through the auditory, tactile, proprioceptive, and visual systems and generated through voice, speech and gestures.

Verbal communication is defined as sharing of information between individuals by using sounds and words.

Non-Verbal communication is defined as behavior and elements of communication that transmit meaning excluding words. Non-verbal communication includes pitch, speed, tone and volume of voice, gestures and facial expressions, body posture, stance, proximity to the listener and eye movements.

Syntax is defined as the set of rules, principles, and processes that govern the structure of sentences in a given language, including word order and grammatical structure of sentences.

Morphology is defined as the set of rules, principles, and processes that govern the structure of words in a given language, including grammatical structure of words.

Semantics is defined as the logical aspects of meaning of words, phrases and sentences, such as sense, reference, implication, and logical form.

Pragmatics is defined as rules for how verbal and nonverbal communication is used in specific social situations and with specific purpose.

Pragmatics has both Social Context Appraisal and Paralinguistic Signals.

Social Context Appraisal is defined as the ability to understand the dynamic nature of a social situation and adequately process the interactions between various contextual variables (such as physical setting & environment, communication partners, communicative intent, conflict/solution, etc). This skill requires an ability to demonstrate perspective taking, understanding of another person's beliefs and perceptions of target social situation.

Paralinguistic Signals is defined as nonverbal communication and ability to appropriately use facial expressions, gestures, and prosody.

Pragmatic Judgement in this context is defined as ability to understand social situations and perceive what correct and incorrect responses in various social contexts are, and is made up of Instrumental Performance Appraisal (IPA), Social Context Appraisal (SCA), and Paralinguistic Decoding (PD).

IPA is defined as ability to discern the difference between appropriate and inappropriate language when used in means-end communication or communication focused on benefitting the self and judge appropriateness of introductions, farewells, politeness, making requests, responding to gratitude, requesting help, answering phone calls, requesting information (e.g., directions), and asking for permission, when provided a specific scenario.

SCA is defined as the ability to understand the dynamic nature of a social situation and adequately process the interactions between various contextual variables (such as physical setting & environment, communication partners, communicative intent, conflict/solution, etc). This skill requires an ability to demonstrate perspective taking, understanding of another person's beliefs and perceptions of target social situation.

PD is defined as a form of non-instrumental communication, which measures the subject's ability to read nonverbal language such as facial expressions and gestures.

Pragmatic Performance in this context is described as ability to produce responses given in social situations to include appropriate answers to questions or statements and appropriate responses to expressed emotions, and is made up of Instrumental Performance (IP), Affective Expression (AE), and Paralinguistic Signals (PS).

IP is defined as ability to appropriately express or use means-end communication or communication focused on benefitting the self such as introductions, farewells, politeness, making requests, responding to gratitude, requesting help, answering phone calls, requesting information (e.g., directions), and asking for permission, when provided a specific scenario.

AE is defined as ability to appropriately use affective communication or communication with purpose to share emotional states or feelings such as regret, support of peers, compliments, humor, empathy, gratitude, encouragement and appropriately use conversational techniques, such as topic selection, maintenance, introduction, transition, and closure.

PS is defined as nonverbal communication and ability to appropriately use facial expressions, gestures, and prosody.

Overall communication skills of an individual are made up of Syntax, Morphology, Semantics, and Pragmatics. These communication skills can be assessed more accurately and precisely with the use of Audio Video Scenes. In addition to more accurate and precise assessments, one is also able to assess elements of communication that could never be assessed in the past. The Audio Video Scenes are presented to the student by an administrator of the assessment, and the student is then asked questions related to the audio video scenes. Based on the audio video scenes and the questions, the administrator of the assessment scores the student on the ability to discern the difference between appropriate and inappropriate communication and/or produce appropriate or inappropriate communication. The administrator then summarizes the scores and compares the student using a comparative scale.

1. Process of assessing a student's communication skills by presenting audio video scenes to the student and asking questions related to the audio video scenes and scoring the students response to the questions and rating the student based on a comparative scale based on the student's scores to the questions.

2. Process of assessing a student's verbal skills by presenting audio video scenes to the student and asking questions related to the audio video scenes and scoring the students response to the questions and rating the student based on a comparative scale based on the student's scores to the questions.

3. Process of assessing a student's non-verbal skills by presenting audio video scenes to the student and asking questions related to the audio video scenes and scoring the students response to the questions and rating the student based on a comparative scale based on the student's scores to the questions.

4. Process of claim 1 wherein presenting audio video scenes related to communication skills involves audio video scenes around syntax, grammatical structure of sentences, wherein questions assess whether an individual can discern the difference between appropriate and inappropriate syntax and/or produce appropriate or inappropriate syntax.

5. Process of claim 1 wherein presenting audio video scenes related to communication skills involves audio video scenes around Morphology, grammatical structure of words, wherein questions assesses whether an individual can discern the difference between appropriate and inappropriate morphology and/or produce appropriate or inappropriate morphology.

6. Process of claim 1 wherein presenting audio video scenes related to communication skills involves audio video scenes around Semantics, meaning of words, wherein questions assesses whether an individual can discern the difference between appropriate and inappropriate semantics and/or produce appropriate or inappropriate semantics

7. Process of claim 1 wherein presenting audio video scenes related communication skills involves audio video scenes around Pragmatics, social language, wherein questions assesses whether an individual can discern the difference between appropriate and inappropriate pragmatics and/or produce appropriate or inappropriate pragmatics.

8. Process of claim 1 wherein presenting audio video scenes related communication skills involves audio video scenes around Social Context Appraisal, social language, wherein questions assesses whether an individual can discern the difference between appropriate and inappropriate pragmatics of social context and/or produce appropriate or inappropriate social context appraisal.

9. Process of claim 1 wherein presenting audio video scenes related communication skills involves audio video scenes around Paralinguistic Signals, social language, wherein questions assesses whether an individual can discern the difference between appropriate and inappropriate pragmatics of paralinguistic signals and/or produce appropriate or inappropriate paralinguistic signals.

10. Process of claim 2 wherein presenting audio video scenes related to verbal skills involves audio video scenes around syntax, grammatical structure of sentences, wherein questions assesses whether an individual can discern the difference between appropriate and inappropriate Syntax and/or produce appropriate or inappropriate Syntax.

11. Process of claim 2 wherein presenting audio video scenes related to verbal skills involves audio video scenes around morphology, grammatical structure of words, wherein questions assesses whether an individual can discern the difference between appropriate and inappropriate morphology and/or produce appropriate or inappropriate morphology.

12. Process of claim 2 wherein presenting audio video scenes related to verbal skills involves audio video scenes around semantics, meaning of words, wherein questions assesses whether an individual can discern the difference between appropriate and inappropriate semantics and/or produce appropriate or inappropriate semantics.

13. Process of claim 2 wherein presenting audio video scenes related to verbal skills involves audio video scenes around pragmatics, social language, wherein questions assesses whether an individual can discern the difference between appropriate and inappropriate pragmatics and/or produce appropriate or inappropriate pragmatics.

14. Process of claim 2 wherein presenting audio video scenes related to verbal skills involves audio video scenes around social context appraisal, social language, wherein questions assesses whether an individual can discern the difference between appropriate and inappropriate pragmatics of social context appraisal and/or produce appropriate or inappropriate social context appraisal.

15. Process of claim 2 wherein presenting audio video scenes related to verbal skills involves audio video scenes around paralinguistic signals, social language, wherein questions assesses whether an individual can discern the difference between appropriate and inappropriate paralinguistic signals and/or produce appropriate or inappropriate paralinguistic signals.

16. Process of claim 3 wherein presenting audio video scenes related to non-verbal skills involves audio video scenes around pragmatics, social language, wherein questions assesses whether an individual can discern the difference between appropriate and inappropriate pragmatics and/or produce appropriate or inappropriate pragmatics.

17. Process of claim 3 wherein presenting audio video scenes related to non-verbal skills involves audio video scenes around social context appraisal, social language, wherein questions assesses whether an individual can discern the difference between appropriate and inappropriate pragmatics of social context appraisal and/or produce appropriate or inappropriate social context appraisal.

18. Process of claim 3 wherein presenting audio video scenes related to non-verbal skills involves audio video scenes around paralinguistic signals, social language, wherein questions assesses whether an individual can discern the difference between appropriate and inappropriate paralinguistic signals and/or produce appropriate or inappropriate paralinguistic signals.

19. Process of claim 2 wherein presenting audio video scenes related to verbal skills involves audio video scenes around instrumental performance, affective expression, paralinguistic signals, social language, wherein questions assesses whether an individual can discern the difference between appropriate and inappropriate instrumental performance, affective expression, paralinguistic signals and/or produce appropriate or inappropriate instrumental performance, affective expression, paralinguistic signals.

20. Process of claim 3 wherein presenting audio video scenes related to non-verbal skills involves audio video scenes around instrumental performance appraisal, social context appraisal, paralinguistic decoding, social language, wherein questions assesses whether an individual can discern the difference between appropriate and inappropriate instrumental performance appraisal, social context appraisal, paralinguistic decoding and/or produce appropriate or inappropriate instrumental performance appraisal, social context appraisal, paralinguistic decoding.
